(19) United States
(12) Patent Application Publication
(10) Pub. No.: US 2019/0258812 A1
(43) Pub. Date: Aug. 22, 2019

(54) MEMORY SECURITY FOR AUTOMOTIVE FUNCTIONAL SAFETY COMPLIANCE WITH INDEPENDENT DOWNSTREAM PROCESSES

(71) Applicant: Sensata Technologies, Inc., Attleboro, MA (US)

(72) Inventors: Eric A. Wolf, Norwood, MA (US); Srinivasan Venkatraman, Natick, MA (US)

(73) Assignee: Sensata Technologies, Inc., Attleboro, MA (US)

(21) Appl. No.: 15/899,555

(22) Filed: Feb. 20, 2018

(51) Int. Cl. G06F 21/62; G06F 9/50; G06F 12/02; G06F 21/81

(52) U.S. Cl. CPC G06F 21/6218; G06F 21/81; G06F 12/0238; G06F 9/5016

(57) ABSTRACT

A single memory space of a device having a dedicated functionality is dynamically partitioned to provide separate memory partitions for access by different processes along a production stream. Firmware in the device that controls the overall functionality of the device also controls partitioning of the memory space. The firmware also controls how each of the partitions may be accessed. The firmware includes a number of different safety features for protecting data in the device and applies each of the safety features utilized by the device to each of the memory partitions. Data security is implemented independently for each partition in order to maintain functional safety compliance of the device. The different partitions can be created and accessed at different points in a production stream by different entities such as a device manufacturer, its customers and suppliers or other entities along the supply chain.

### FIELD OF TECHNOLOGY

The present disclosure is in the field of computer memory and more particularly in the field of functional safety of data in embedded component memory.

### BACKGROUND

Increasing numbers of electromechanical components include some computer processing capability and memory for storing data and computer program instructions. The data and stored program instructions in the memory can be susceptible to unauthorized access or corruption at various stages of production and thereafter.

Complex systems including advanced automobiles and trucks include numerous electronic control units in communication with on-board sensor and actuators, for example. Advanced automotive systems may also communicate wirelessly to an operator's mobile device, or to a wireless network for communicating system status or for updating software and date in the electronic control units.

FIG. 1 is a high level block diagram illustrates some of the electronic control unit functionalities of an automobile that may be susceptible to unauthorized access and unauthorized alteration of data. The illustrative automobile 100 may include an engine and transmission ECU 102, a steering and braking ECU 104 and airbag ECU 106, a lighting system ECU 108, a vehicle access system ECU 110, and an advanced driver assistance system ECU 112, for example. Each ECU may contain its own processor and memory and may be configured to communicate with various sensors and actuators and with one or more of the other ECUs. The automobile 100 may also include Bluetooth circuitry 114 and universal serial bus (USB) ports 116 for communicating with an operator's and/or passenger's wireless devices 118 such as key fobs, smart phones, tablets and computers, for example. Other dedicated apparatus such as pressure sensors 120, temperature sensors 122, speed sensors 124, acceleration sensors 126, engine actuators 128, braking actuators 130, and airbag actuators 132 may be electrically coupled or wirelessly coupled to the various electronic control units. These devices may include their own processors and memory.

Complex systems that include electronic control units, and other dedicated electronic apparatus, especially those that include wireless communication capabilities, can be susceptible to unauthorized access that could degrade system safety and performance. Such unauthorized access may be possible during the system's operation, or even in the manufacturing process of the system or system components.

In some industries, including the automotive industry, components that store data are subject to functional safety standards and other regulations that require manufacturers to assure that data and program instructions stored in component memory is protected from unauthorized access. Component manufacturers can comply with these standards and regulations by implementing component circuitry that locks down component memory and prevents unauthorized reading or alteration of data and program instructions after they are stored in the memory.

Blocking further access to component memory after a manufacturing process is complete becomes problematic when downstream manufacturing processes could benefit from access to the memory. As component electronics become more sophisticated, system level manufacturers and other downstream processes involving a component may need to use memory space in the component for different tasks within their system. Multiple levels of manufacturing processes may require write access to component memory to store different data and program instructions. However, memory that is locked down after an upstream manufacturing process will not be available for use by the downstream processes.

Traditionally, component manufacturers have included separate blocks of memory in a component in which one block of memory can be locked down after an upstream manufacturing process so that data stored in that block cannot be altered. Another block of the memory in the component remains accessible to downstream processes. Multiple downstream processes may sequentially write to and then lock down their own block of memory in the component, for example. However, providing separate blocks of memory for different access during sequential manufacturing processes is inefficient from both a cost and data storage perspective.

### SUMMARY

According to an aspect of the present disclosure a device includes a single memory space that can be dynamically partitioned by the device to provide separate memory partitions for access by different processes along a production stream. Providing multiple partitions in the single memory space is much less costly than providing separate memory blocks. Moreover, dynamically partitioned memory can be sized more appropriately according to the amount of memory needed by a corresponding process. The more appropriately sized partitions provide for more efficient use of memory space.

Firmware in the device, which controls the overall functionality of the device, also controls partitioning of the memory space. According to an aspect of the present disclosure, the firmware also controls how each of the partitions may be accessed. For example, in order to comply with functional safety standard ISO 26262, the firmware of a device may include a number of different safety features for protecting data in the device. The firmware can apply each of the safety features utilized by the device to each of the memory partitions. This ensures that each of the memory safety features that are in place to ensure data security are implemented independently for each partition in order to maintain functional safety compliance of the device.

The different partitions can be created and accessed at different points in a production stream by different entities such as a device manufacturer, its customers and suppliers or other entities along the supply chain. The different entities can write whatever data, program instructions or whatever information they need into the component and activate the security features they need in order for the device to meet ISO 26262 requirements.

### BRIEF DESCRIPTION OF THE DRAWINGS

A better understanding of aspects of the present disclosure will be facilitated upon reference to the following detailed description when read in conjunction with the accompanying drawings wherein like reference characters refer to like parts throughout the drawings, in which:

FIG. 1 is high level block diagram illustrating examples of electronic control units, sensors and actuators in an advanced automobile.

FIG. 2 is system block diagram of an apparatus for performing a dedicated function according to an aspect of the present disclosure.

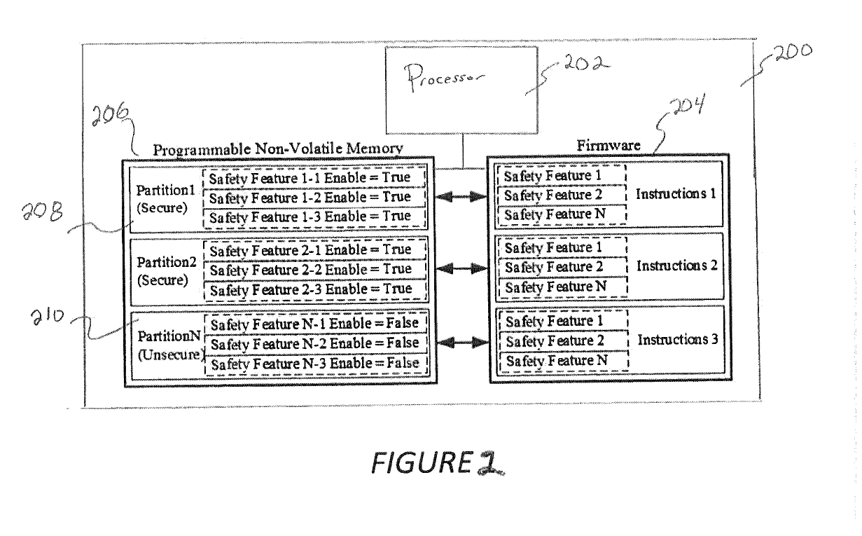

FIG. 3 is a process flow diagram showing a method for securing data on an apparatus for performing a dedicated function according to an aspect of the present disclosure.

### DETAILED DESCRIPTION

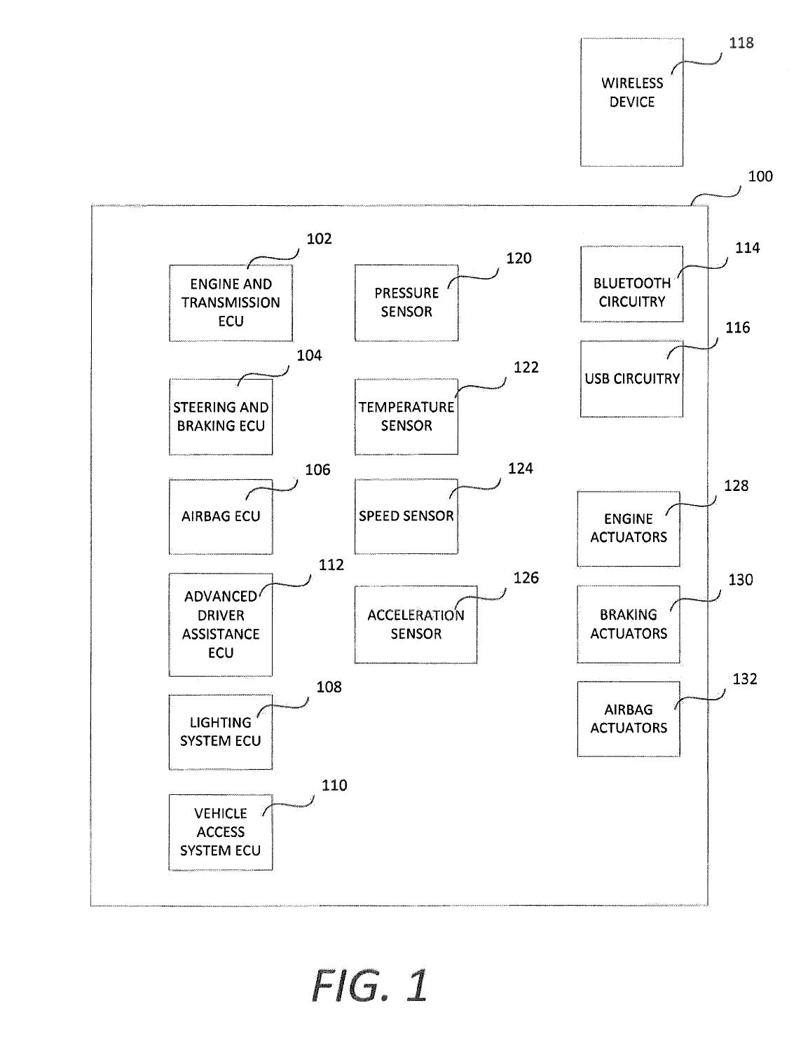

Referring to FIG. 1, aspect of the present disclosure include an apparatus 100 for performing a dedicated function. The apparatus 200 may be an electromechanical device such as an automotive sensor, a switching component, an actuator, an automotive electronic control unit, or other dedicated electronic component, for example. The apparatus 200 includes at least one processor 202, firmware 204 in communications with the processor 202, and programmable non-volatile memory 206 coupled to the firmware 204. According to an aspect of the present disclosure, the programmable non-volatile memory has programmable operational characteristics.

Instructions are stored on the firmware 204 and are executable by the processor 202 to configure a first partition 208 of the programmable non-volatile memory 206. The instructions implement a first set of safety features of the programmable non-volatile memory 206 with respect to the first partition 208. The first set of safety features includes preventing alteration of data in the first partition 208 after completion of a first manufacturing process, for example.

According to an aspect of the present disclosure the firmware 204 also includes instructions that are executable by the processor 202 to facilitate performance of the dedicated function of the apparatus 200 using the data stored in the programmable non-volatile memory 206.

The firmware 204 also includes instructions executable by the processor 202 to configure a second partition 210 of the programmable non-volatile memory 206 and to implement a second set of safety features of the programmable non-volatile memory 206 with respect to the second partition 210. The second set of safety features includes preventing alteration of data in the second partition after completion of a second manufacturing process, for example.

According to an aspect of the present disclosure, a programmable operational characteristic of the programmable non-volatile memory determines partition boundaries of the first partition and the second partition based on data storage requirements of the first manufacturing process and the second manufacturing process.

According to an aspect of the present disclosure, a programmable operational characteristic of the programmable non-volatile memory determines partition boundaries of the first partition and the second partition based on data storage requirements of the first manufacturing process and the second manufacturing process.

In an illustrative embodiment, the instructions stored on the firmware are executable by the processor to configure an nth partition of the programmable non-volatile memory, and to implement an nth set of safety features of the programmable non-volatile memory in the nth partition, wherein the nth of safety features includes preventing alteration of data in the nth partition after completion of an nth manufacturing process. A programmable operational characteristic of the programmable non-volatile memory determines partition boundaries of the nth partition based on data storage requirements of the nth manufacturing process.

In a particular illustrative embodiment, the dedicated function of the apparatus is sensing a pressure. In another illustrative embodiment, the dedicated function of the apparatus is switching an electrical pathway.

According to an aspect of the present disclosure, the programmable non-volatile memory comprises an electrically erasable programmable read-only memory (EEPROM), a flash memory, or a one-time programmable memory, for example. According to another aspect of the present disclosure, the first set of safety features include instructions in the firmware configured to prevent unauthorized alteration of the firmware. The first set of safety features and the second set of safety features comply with a standard of functional safety for electrical and/or electronic systems in production automobiles. In an illustrative embodiment, the standard of functional safety comprises International Organization for Standardization (ISO) standard 26262.

At least one of the first manufacturing process and the second manufacturing process comprises writing instructions for performing the dedicated function in the firmware.

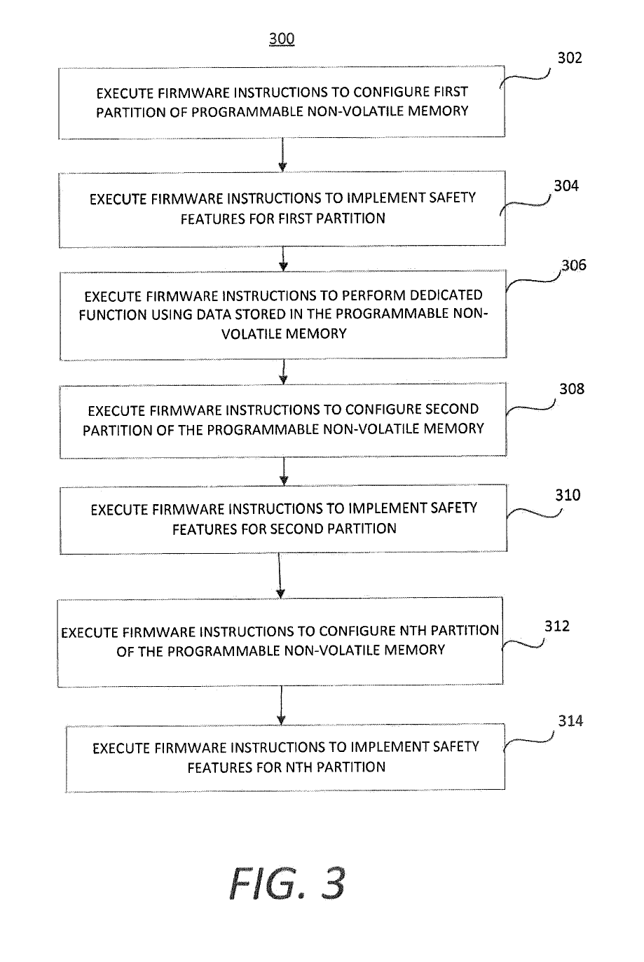

Another aspect of the present disclosure includes a method 300 for securing data on an apparatus for performing a dedicated function. The method includes operating firmware instruction of the apparatus to perform the procedural steps shown in FIG. 3. At step 302, the method including executing firmware instructions of the apparatus to configure a first partition of a programmable non-volatile memory of the apparatus, wherein the programmable non-volatile memory has programmable operational characteristics. The programmable non-volatile memory may be an EEPROM, a flash memory, or a one-time programmable memory, for example.

At step 304, the method includes executing the firmware instructions of the apparatus to implement a first set of safety features of the programmable non-volatile memory in the first partition, wherein the first set of safety features includes preventing alteration of data in the first partition after completion of a first manufacturing process. At step 306, the method includes executing the firmware instructions of the apparatus to facilitate performance of the dedicated function using the data stored in the programmable non-volatile memory. At step 308, the method includes executing the firmware instructions of the apparatus to configure a second partition of the programmable non-volatile memory. At step 310, the method includes executing the firmware instructions of the apparatus to implement a second set of safety features of the programmable non-volatile memory in the second partition, wherein the second set of safety features includes preventing alteration of data in the second partition after completion of a second manufacturing process.

In an embodiment, the method includes determining partition boundaries of the first partition and the second partition based on data storage requirements of the first manufacturing process and the second manufacturing process. According to an aspect of the present disclosure, the configuration of petition boundaries to prevent alteration of data in the first partition after completion of a first manufacturing process and to prevent alteration of data in the second partition after the second manufacturing process is a programmable operational characteristic of the programmable non-volatile memory.

In an illustrative embodiment, the method may include executing the firmware instructions of the apparatus to configure an nth partition of the programmable non-volatile memory at step 312 and to implement an nth set of safety features of the programmable non-volatile memory in the third partition at step 314, wherein the nth of safety features includes preventing alteration of data in the third partition after completion of an nth manufacturing process. The programmable operational characteristic of the programmable non-volatile memory determines partition boundaries of the nth partition based on data storage requirements of the nth manufacturing process.

In the method 300 for securing data on an apparatus for performing a dedicated function, the dedicated function of the apparatus may include sensing a pressure, or switching an electrical pathway, for example. In an illustrative embodiment, the first set of safety features may include instructions in the firmware configured to prevent unauthorized alteration of the firmware. At least one of the first manufacturing process and the second manufacturing process comprises writing instructions to the firmware for performing the dedicated function.

In the method 300, the first set of safety features and the second set of safety features may comply with a standard of functional safety for electrical and/or electronic systems in production automobiles, such as International Organization for Standardization (ISO) standard 26262, for example.

The disclosed apparatus for performing a dedicated function may include a computer program product that when executed on the apparatus causes the apparatus to perform the dedicated function, to partition a programmable non-volatile memory of the apparatus, and to separately secure functional safety of multiple partitions of the programmable non-volatile memory.

An illustrative embodiment according to an aspect of the present disclosure includes a non-transitory computer readable medium that includes computer executable program code embodied thereon. The program code includes executable instructions for performing a dedicated function of the apparatus, in addition to executable instructions for implementing safety features to comply with functional safety standards. The executable instructions include instructions to configure a first partition of a programmable non-volatile memory of the apparatus and to implement a first set of safety features of the programmable non-volatile memory in the first partition. According to an aspect of the present disclosure the first set of safety features includes preventing alteration of data in the first partition after completion of a first manufacturing process.

The executable instructions also include instructions to facilitate performance of the dedicated function using the data stored in the programmable non-volatile memory, to configure a second partition of the programmable non-volatile memory and to implement a second set of safety features of the programmable non-volatile memory in the second partition. According to an aspect of the present disclosure, the second set of safety features includes preventing alteration of data in the second partition after completion of a second manufacturing process.

In an illustrative embodiment, the program code further comprises instructions executable to configure an nth partition of the programmable non-volatile memory, and to implement an nth set of safety features of the programmable non-volatile memory in the third partition, wherein the nth of safety features includes preventing alteration of data in the third partition after completion of an nth manufacturing process. In an illustrative embodiment, a programmable operational characteristic of the programmable non-volatile memory determines partition boundaries of the nth partition based on data storage requirements of the nth manufacturing process.

Alternatively and/or additionally, in some embodiments, special purpose logic circuitry, e.g., an FPGA (field programmable gate array), a DSP processor (as in the case of, for example, some of the programmable sensors described herein), or an ASIC (application-specific integrated circuit) may be used in the implementation of the disclosed apparatus.

Computer programs (also known as programs, software, software applications or code) include machine instructions for a programmable processor, and may be implemented in a high-level procedural and/or object-oriented programming language, and/or in assembly/machine language. As used herein, the term “computer-readable medium” refers to any non-transitory computer program product, apparatus and/or device (e.g., magnetic discs, optical disks, memory, EPROMS, Programmable Logic Devices (PLDs) and the like) used to provide machine instructions and/or data to a programmable processor, including a non-transitory machine-readable medium that receives machine instructions as a machine-readable signal.

While particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

1. An apparatus for performing a dedicated function, the apparatus comprising
at least one processor;
firmware in communications with the processor;
programmable non-volatile memory coupled to the firmware, the programmable non-volatile memory having programmable operational characteristics; and
instructions stored on the firmware and executable by the processor to:
configure a first partition of the programmable non-volatile memory,
implement a first set of safety features of the programmable non-volatile memory in the first partition, wherein the first set of safety features includes preventing alteration of data in the first partition after completion of a first manufacturing process;
facilitate performance of the dedicated function using the data stored in the programmable non-volatile memory;
configure a second partition of the programmable non-volatile memory;
implement a second set of safety features of the programmable non-volatile memory in the second partition, wherein the second set of safety features includes preventing alteration of data in the second partition after completion of a second manufacturing process;
wherein a programmable operational characteristic of the programmable non-volatile memory determines partition boundaries of the first partition and the second partition based on data storage requirements of the first manufacturing process and the second manufacturing process.

2. The apparatus of claim 1, comprising instructions stored on the firmware and executable by the processor to:
configure an nth partition of the programmable non-volatile memory; and
implement an nth set of safety features of the programmable non-volatile memory in the third partition, wherein the nth of safety features includes preventing alteration of data in the third partition after completion of an nth manufacturing process;
wherein a programmable operational characteristic of the programmable non-volatile memory determines partition boundaries of the nth partition based on data storage requirements of the nth manufacturing process.

3. The apparatus of claim 1, wherein the dedicated function comprises sensing a pressure.

4. The apparatus of claim 1, wherein the dedicated function comprises switching an electrical pathway.

5. The apparatus of claim 1, wherein the programmable non-volatile memory comprises an electrically erasable programmable read-only memory.

6. The apparatus of claim 1, wherein the first set of safety features include instructions in the firmware configured to prevent unauthorized alteration of the firmware.

7. The apparatus of claim 1, wherein at least one of the first manufacturing process and the second manufacturing process comprises writing instructions to the firmware for performing the dedicated function.

8. The apparatus of claim 1, wherein the first set of safety features and the second set of safety features comply with a standard of functional safety for electrical and/or electronic systems in production automobiles.

9. The apparatus of claim 8, wherein the standard of functional safety comprises International Organization for Standardization (ISO) standard 26262.

10. A method for securing data on an apparatus for performing a dedicated function, the method including executing firmware instructions of the apparatus to:
configure a first partition of a programmable non-volatile memory of the apparatus, the programmable non-volatile memory having programmable operational characteristics;
implement a first set of safety features of the programmable non-volatile memory in the first partition, wherein the first set of safety features includes preventing alteration of data in the first partition after completion of a first manufacturing process;
facilitate performance of the dedicated function using the data stored in the programmable non-volatile memory;
configure a second partition of the programmable non-volatile memory; and
implement a second set of safety features of the programmable non-volatile memory in the second partition, wherein the second set of safety features includes preventing alteration of data in the second partition after completion of a second manufacturing process;
wherein a programmable operational characteristic of the programmable non-volatile memory determines partition boundaries of the first partition and the second partition based on data storage requirements of the first manufacturing process and the second manufacturing process.

11. The method of claim 10, further comprising executing firmware instructions of the apparatus to
configure an nth partition of the programmable non-volatile memory; and
implement an nth set of safety features of the programmable non-volatile memory in the third partition, wherein the nth of safety features includes preventing alteration of data in the third partition after completion of an nth manufacturing process;
wherein a programmable operational characteristic of the programmable non-volatile memory determines partition boundaries of the nth partition based on data storage requirements of the nth manufacturing process.

12. The method of claim 10, wherein the dedicated function comprises sensing a pressure.

13. The method of claim 10, wherein the dedicated function comprises switching an electrical pathway.

14. The method of claim 10, wherein the programmable non-volatile memory comprises an electrically erasable programmable read-only memory.

15. The method of claim 10, wherein the first set of safety features include instructions in the firmware configured to prevent unauthorized alteration of the firmware.

16. The method of claim 10, wherein at least one of the first manufacturing process and the second manufacturing process comprises writing instructions to the firmware for performing the dedicated function.

17. The method of claim 10, wherein the first set of safety features and the second set of safety features comply with a standard of functional safety for electrical and/or electronic systems in production automobiles.

18. The method of claim 17, wherein the standard of functional safety comprises International Organization for Standardization (ISO) standard 26262.

19. A non-transitory computer readable medium comprising computer executable program code embodied thereon, the program code including executable instructions for performing a dedicated function of an apparatus, the program code further comprising instructions executable to:
configure a first partition of a programmable non-volatile memory of the apparatus,
implement a first set of safety features of the programmable non-volatile memory in the first partition, wherein the first set of safety features includes preventing alteration of data in the first partition after completion of a first manufacturing process;
facilitate performance of the dedicated function using the data stored in the programmable non-volatile memory;
configure a second partition of the programmable non-volatile memory;
implement a second set of safety features of the programmable non-volatile memory in the second partition, wherein the second set of safety features includes preventing alteration of data in the second partition after completion of a second manufacturing process.

20. The non-transitory computer readable medium of claim 19, wherein the program code further comprises instructions executable to
configure an nth partition of the programmable non-volatile memory; and
implement an nth set of safety features of the programmable non-volatile memory in the third partition, wherein the nth of safety features includes preventing alteration of data in the third partition after completion of an nth manufacturing process.
